(19) United States
(12) Patent Application Publication
(10) Pub. No.: US 2026/0317515 A1
(43) Pub. Date: Oct. 15, 2026

(54) A MATERIAL

(71) Applicant: FERGUSSON'S ADVANCED COMPOSITE TECHNOLOGY LIMITED, Greater London (GB)

(72) Inventors: Alexander NEWMAN, Greater London (GB); Alexander FERGUSSON, Greater London (GB); Declan CAROLAN, Greater London (GB); Sammy HE, Greater London (GB); George IRVEN, Greater London (GB)

(73) Assignee: FERGUSSON'S ADVANCED COMPOSITE TECHNOLOGY LIMITED, Greater London (GB)

(21) Appl. No.: 19/483,264

(22) PCT Filed: May 13, 2024
(86) PCT No.: PCT/GB2024/051238

§ 371 Date: Nov. 11, 2025

(30) Foreign Application Priority Data
May 12, 2023 (GB) 2307079.0

(51) Int. Cl. C08K 7/28

(52) U.S. Cl. CPC C08K 7/28; C08K 2201/003; C08K 2201/005

(57) ABSTRACT

A material comprising a plurality of first microparticle, the first microparticle having a first crush strength and a first density, and a plurality of second microparticle, the second microparticle having a second crush strength and a second density. A matrix material is provided to bind the microparticles. The crush strength of the first microparticle is greater than the tensile strength of the matrix material and the matrix material constitutes less than 40% of the material volume. The density of the first microparticle is greater than, or equal to, the density of the second microparticle and both the first microparticle and the second microparticle have a density less than the matrix material.

### FIELD OF THE INVENTION

The invention relates to a lightweight material, particularly to a light composite material, which may be used as a potting compound or as a syntactic foam.

### BACKGROUND TO THE INVENTION

In various fields of technology, there is a desire for lightweight and strong materials. Where the material is to be used, it can be particularly important that it has a low density and yet is mechanically strong. For example, in adhesives, sheet materials, such as cladding, and packaging.

As one example, potting compounds are used to seal electronic circuits and to provide resistance to shock and vibration. In some circumstances, particularly where weight is a concern such as in the aviation industry or the automotive industry, it is desirable for potting compounds to be light weight. Hitherto, potting compounds have been made from polyurethane or silicone or other lightweight resins. Some potting compounds incorporate microspheres within the resin to reduce the weight, known as “syntactic potting compounds”; however, whilst the microspheres can reduce the density of the potting material, the resulting material may still be relatively heavy and may also be relatively weak and vulnerable to failure when under load.

Another area in which the weight of products is important in the aviation industry is in respect of the weight of a cargo pallet and also the aircraft itself. There is a desire to reduce the weight of aircraft and cargo pallets to increase fuel efficiency.

Conventionally, this has been achieved by the use of hollow microspheres held within a matrix material, for example, syntactic foams. The obvious way in which to decrease the weight of the material is to increase the diameter of the microspheres therein, whilst keeping the same, or similar, wall thickness of the hollow microsphere; however, whilst this can decrease the density of the resulting material, the strength of the material, particularly the crush strength and the shear strength can be compromised to an extent that the material is no longer suitable, because it cannot withstand the forces to which it is subjected in normal use.

### SUMMARY OF THE INVENTION

Accordingly, the present invention is directed to a material comprising:
a plurality of first microparticle, the first microparticle having a first crush strength and a first density;
a plurality of second microparticle, the second microparticle having a second crush strength and a second density; and
a matrix material;
   wherein the crush strength of the first microparticle is greater than the tensile strength of the matrix material;
wherein the matrix material constitutes less than 50% of the material volume; and
wherein the density of the first microparticle is greater than, or equal to, the density of the second microparticle and both the first microparticle and the second microparticle have a density less than the matrix material.

Thus, the present invention is a material in which there are at least two types of microparticles, with the first microparticle being denser than the second microparticle and both microparticle types being less dense than the matrix material that binds them together. Additionally, the crush strength of the first microparticle is greater than the tensile strength of the matrix material, so that, when subjected to a mechanical force, it is more likely that the matrix material will fail before the microparticles fail. Such a combination creates a lightweight and strong material. The matrix material should, preferably, be sufficient to provide a continuous phase around the microparticles. This may mean that at least 5% of the material should be matrix material, which may increase up to 50%, depending upon the first and second microparticles.

In general, small microparticles are strong and dense and so these are, preferably, used as the first microspheres, and larger microparticles are less dense and weaker than small microparticles and so these are, preferably, used as the second microparticles. Thus, the second, larger, microparticles will form the bulk of the material; however, the smaller microparticles provide strength to the material. This preferred arrangement results in a low density and high strength product, when combined with the matrix material. As strong microparticles tend to be heavier and more expensive, and weaker microparticles generally are cheaper and lighter, the resulting product may also be less expensive than existing products.

The material may be used to create a potting compound, which could be employed to protect a circuit board, or it could be used in composite structure for example, as the core of a composite structure or composite material. Similarly, the material may be used as a lightweight adhesive or structure. Additionally, the material may be used in manufacturing applications due to it being surprisingly strong for its light weight. A further use may be as a fixative potting compound for securing elements in place.

“microparticle” is intended to mean a particle with a maximum dimension of between 0.2 microns and 1000 microns. Whilst it will be appreciated that microspheres are not always perfectly spherical, the maximum dimension of the microsphere should be within the range set out above. Microspheres used in the present invention may be between 10 microns and 100 microns. In one arrangement, the first microparticle has a diameter of between 50 microns and 100 microns and the second microparticle has a diameter of between 10 microns and 40 microns. Such an arrangement will provide larger microparticles to reduce the overall density of the material, whilst the smaller microparticles provide strength to the material.

Preferably, the matrix material constitutes less than 40% or less than 30% of the material volume and, more preferably, the matrix material constitutes less than 20% of the material volume; however, the matrix material should provide a continuous phase around the microparticles, which can ensure that the microparticles are held together. It is particularly advantageous that the matrix material, which is denser than the microparticles, forms less of the material than the microparticles themselves. This reduces the density of the resulting product, however, as the random close packing limit of a material with a single type of microparticles is around 63%, the present invention comprises two types of microparticle that can be selected to produce a particularly high packing density, thereby reducing the amount of matrix material in the product. It will be noted that matrix material is required in order to bind the two types of microparticle together securely and so it must be present in a non-zero amount; however, by having both large microparticles and small microparticles in the material, the packing fraction of the microparticles is increased, thereby reducing the amount of matrix material required to bind them. It should be noted that where the material should flow, for example, it acts like a liquid, it may be desirable to use a volume fraction of less than 50%, which then provides space for the microparticles to flow in the matrix material; however, when material is intended to flow less, for example, it acts like a solid material, the packing fraction can be higher so that the microparticles are more in contact with each other. Thus, the material may be solid, quasi-solid or liquid, depending upon the intended application and/or purpose of the material. It will further be appreciated that the material may be a liquid that can later set into a more solid structure. The matrix material will, preferably, be present at a minimum amount of at least 1% of the overall material volume.

In one arrangement, the crush strength of the first microparticle is greater than the crush strength of the second microparticle, and it is advantageous that the crush strength of the first microparticle is greater than 20 MPa, but it may be higher than 30 MPa, 40 MPa, 50 MPa or, in some cases higher than 60 MPa. Such crush strengths provide strength to the resulting material. In some arrangements, the crush strength of the second microparticle will be greater than 80 MPa and, preferably, greater than 100 MPa, which can provide a high level of crush resistance to the resulting product.

It is advantageous that the density of the second microparticle is less than 600 kg/m³, and it may be further advantageous that the density of the second microparticle is less than 400 kg/m³. As the second microparticle forms the largest part of the material, having a low density for the second microparticle is particularly advantageous, and it has been found that a density of less than 600 kg/m³ is particularly beneficial with less than 400 kg/m³ having a further benefit to the material. In some arrangements, the first microparticle may have a density between 0.1 g/cc and 0.3 g/cc and the second microparticle may have a density between 0.3 g/cc and 0.9 g/cc.

In a preferrable embodiment, the first microparticle and/or the second microparticle is selected from a group comprising: ceramic microspheres; glass microspheres; metal microspheres; polymer microspheres; microballoons; microspheroids; fibres; and platelets. Whilst it is preferable to have hollow microparticles, other types of particles may be employed where the density is sufficiently low. The use of non-spheroidal microparticles may assist with increasing the packing of the microparticles within the material. Similarly, the non-spheroidal microparticles can provide additional properties to the material, such as increasing the resistance to shear stresses and/or compression stress.

In some arrangements, it may be useful to provide a plurality of third microparticles in the material, and that third microparticle may be selected from a group comprising: glass microspheres; ceramic microspheres; metal microspheres; polymer microspheres; microballoons; microspheroids; fibres; and platelets. To reduce the amount of matrix material required and/or to improve the mechanical properties of the material, a third type of microparticle can be added into the material.

In the present invention, it may be particularly beneficial to have an arrangement in which the plurality of first microparticles forms a structural percolated network within the material. A structural percolated network is considered to be analogous to the concept of electric percolation in electrical composite materials, but providing enhanced mechanical performance, rather than electrical conductivity. This is to say that it is an arrangement in which the first microspheres form structural support within the material. The structural percolation may form a crush resistant support between opposing surfaces of the material. Thus, when the matrix material is incorporated into the mixture, a composite material is formed. In the resulting product, a scaffold of first microparticles may be established between opposing surfaces to give the material structural strength. The second microparticles can be used to reduce the weight, with the majority of the load resistance being provided by the network of first microparticles. The structural percolation for a single type of microparticle requires a much higher volume fraction than in the present invention that employs at least two types of microparticle. Benefits of the present invention are more clearly displayed where there the two types of microparticle allow for the structural support provided by stronger microparticles combined with the low density of larger particles, which is derived from the structural percolated network. The ratio of the particles may be particularly relevant in forming the structural percolation.

It is envisaged that the matrix material may be a thermoset polymer or a thermoplastic polymer, although other matrix materials may be suitable in particular applications. For example, an epoxy polymer may be particularly useful in some arrangements. These matrix materials provide a particularly useful yield strength, thereby keeping the microparticles bound together when under stress. It will be appreciated that other matrix materials may be use, such as metals, ceramics or glass.

The ratio of the maximum dimension of first microparticles to the maximum dimension of second microparticles may be between 1:1 and 7:1, depending upon the intended use of the material and the required properties of the resulting material. The ratios, or ranges of ratios, may be integer values within the aforementioned range, for example, 2:1 to 6:1 or 4:1 to 7:1, and it will be appreciated that non-integer ratios or ranges of ratios may also be useful in some applications, for example, 5:2, 7:2, 4:3 or 3:2 to 9:2 etc. The range may be a sub-set of the aforementioned range. It may be that the first microparticles have a maximum dimension that is half of that of the second microparticles, although it may be a third or a quarter of the maximum dimension. It will be appreciated that the ratios may be applied not only numerically, but also in respect of the volume of the microparticles. Thus, the first microparticle can have a first volume and the second microparticle be a fraction of that first volume, for example, if the first microparticle has a first volume, the volume of the second microparticle may be, 50% of the first volume, or 25% of the first volume.

It is advantageous that the volume of the first plurality of microparticles is in a range of between 20% and 70% of the total amount of microparticles, and, preferably, between 30% and 60%, 40% to 55% or 40% to 65% or 70%. The remaining volume is the amount of the second plurality of microspheres present in the material. Clearly, the matrix material will also be present to the extent that it binds the microparticles together. This provides a sufficiently light weight material, which is able to usefully resist loads, thereby making the material particularly useful.

In one arrangement, it may be preferable for the material to be thermally conductive. As an example, the microparticles may have a high thermal conductivity. This might be achieved by using metal microspheres.

In one arrangement, the present invention provides light, big and weak microspheres in combination with strong, small and slightly less light microspheres in a specific combination dictated by the relative size difference of the microspheres. When these are combined with a binder material matrix, the result provides a surprising benefit in terms of the end product having both composite lightness, due to better packing, and strength, due to the structural percolation. The smaller microspheres can provide resistance to forces be providing an internal scaffold structure between the external surfaces, whilst the larger microspheres decrease the overall density.

The invention further extends to a method of making a material described herein, wherein the method comprises the steps of providing the first microparticles and providing the second microparticles, mixing those with a matrix material, to form the material, which may be a composite material.

Preferably, the ‘dry’ components of the material, that is to say, the microparticles and any other additional elements, are combined and mixed, prior to the addition of the matrix material. This allows the microparticles to mix in a beneficial manner, prior to the matrix material being added. It will be appreciated that the matrix material may reduce the ease with which the microparticles combine. Alternatively, one of the microparticle types or a different ‘dry’ component might be mixed with the matrix material and that matrix material mixture can be added to the other components. Mixing the dry microparticles will naturally result in a random packing that creates a structural percolation in the mix. As the matrix material is added to the ‘dry’ mix, that structural percolation is locked in place, thereby providing the material with structural rigidity and resistance to compressive forces applied thereto.

When forming the material, this may involve a step of forming, curing or setting where the material is a solid structure; however, where the material is a liquid or quasi-solid, the microparticles and matrix material may be mixed. Again, during agitation of the mixture of the microparticles and the matrix material, if completely mixed, the components will form a structural percolation that can be fixed in place. Thus, the microparticles should be thoroughly agitated, which may require mixing of the microparticles for at least five minutes to ensure that the random packing of the particles forms the structural percolated network. One method for undertaking such mixing is a 3-dimensional shaker/mixer that is employed for homogeneous mixing of substances. Such a mixer is often used for powders and to obtain a homogeneous mix of components.

Once the microparticles have been mixed the matrix material can be introduced into the dry mix and the mixing continued to ensure that the matrix material is sufficiently dispersed through the mixture to bond the microparticles together, after which the curing process can be undertaken.

### BRIEF DESCRIPTION OF THE DRAWINGS

Embodiments of the invention will now be described, by way of example only, and with reference to the accompanying drawings, in which:

FIG. 1 shows a schematic cross-sectional view of a material comprising a first type of microparticle;

FIG. 2 shows a schematic cross-sectional view of a material comprising a second type of microparticle;

FIG. 3 shows a schematic perspective view of an arrangement of microparticles in a material in accordance with the present invention;

FIG. 4 is a schematic cross-sectional view of a material in accordance with the present invention; and

FIG. 5 is a graph showing the normalised specific strength of a material against the volume of the first plurality of microparticle.

### DETAILED DESCRIPTION OF EXEMPLARY EMBODIMENTS

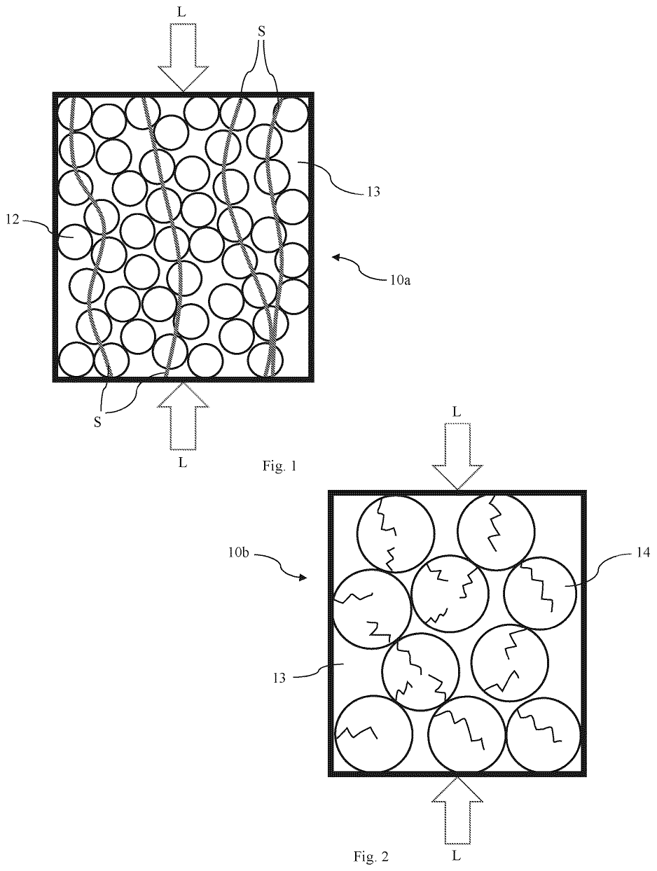

FIG. 1 shows a section of material 10a that is made up from a plurality of first microparticles, in the form of hollow microspheres 12, although they could be a different microparticle. In this arrangement, the first microspheres 12 are packed within a matrix material 13. The microspheres 12 have a relatively small diameter and are strong, thus, as shown in the figure, when a load L is applied to the material, the force passes through adjacent microspheres 12, and a stress path S is created that resists the load. As a result, the material 10a of FIG. 1 is able to withstand significant loads; however, whilst relatively strong, it is also relatively dense.

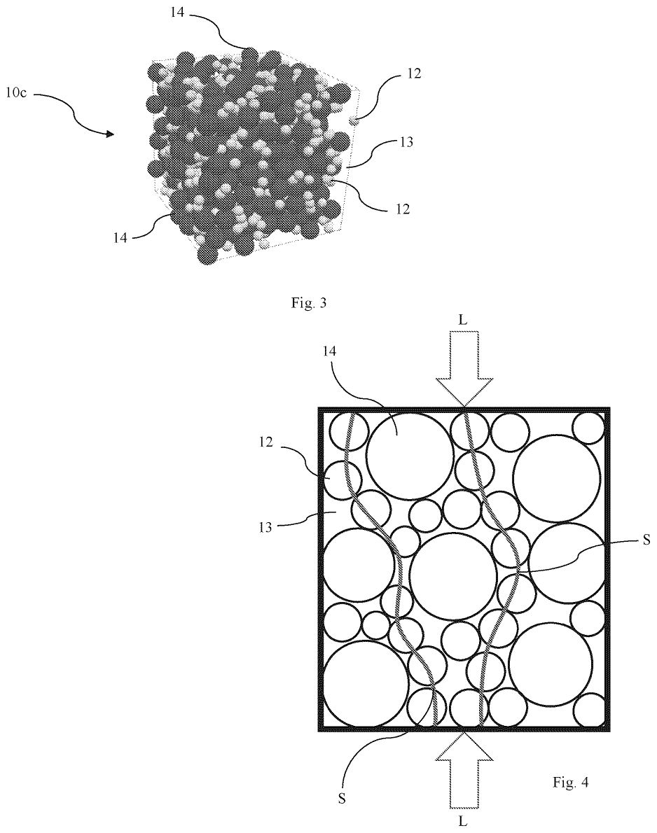

FIG. 2 shows a section of material 10b that is made up from a plurality of second microparticles, in the form of hollow microspheres 14, which could be a different type of microparticle. In this arrangement, the second microspheres 14 are packed within a matrix 13, and the microspheres 14 have a relatively large diameter. The microspheres 14 are relatively weak but are lightweight. As a result, although the resulting material 10b of FIG. 2 has a relatively low density, when a load L is applied to the material, the microspheres 14 are unable to resist the load L and so fracture, as shown in FIG. 2. Therefore, whilst the material is lightweight, it is relatively weak and not practical for many applications.

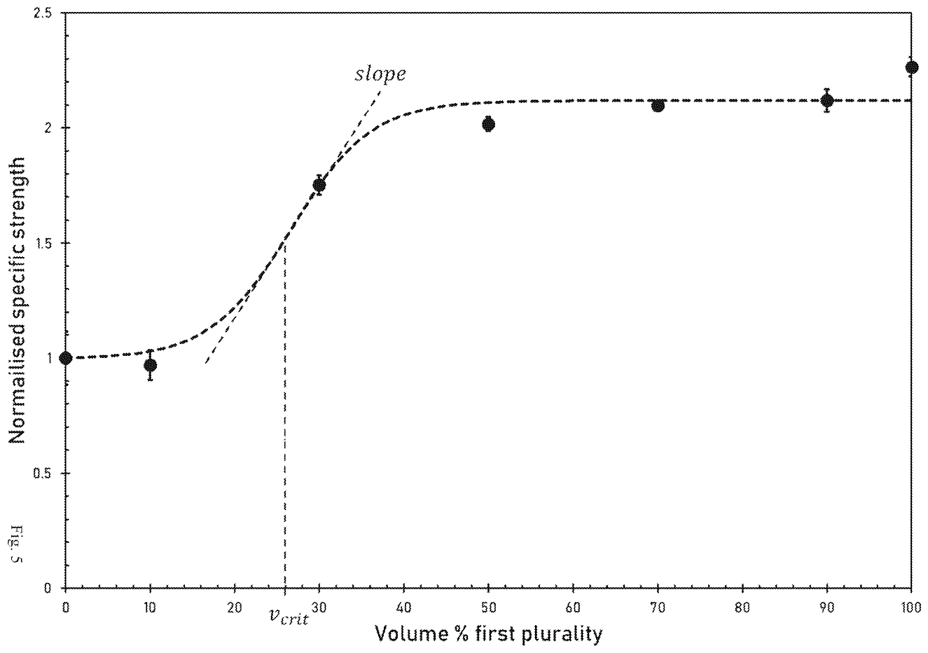

FIGS. 3 and 4 show a section of material 10c, having a plurality of first microparticles 12 and plurality of second microparticles 14, mixed together in a matrix material 13. As can be seen from the figure, the first microparticles 12 have a volume that is less than that the second microparticles 14, and the density of the first microparticles 12 is greater than that of the second microparticles. Due to the difference in size between the first microparticles 12 and the second microparticles 14, the first microparticles 12 can fit into the gaps between the second microparticles 14 in a random packing. Thorough agitation of the microparticles will naturally result in the structural percolation being formed. As the microparticles 12/14 are packed more densely than those of FIG. 2, less of the matrix material 13 is required per given volume of material. It will be appreciated that as the density of the microparticles 12/14 is less than that of the matrix material 13 which holds microparticles together, either as a liquid or a solid, the overall density of the resulting material 10c is less than that shown in FIG. 1, whilst still maintaining similar resistance to load L.

Additionally, as shown more clearly in FIG. 4, a structural percolation occurs within the material, whereby the first microparticles 12 can form a stress path S through the material, which provides strength when a load L is applied to the material. Thus, where a force L is applied to, for example, the top surface of the material, the structural percolation of the first microparticles 12 within the material provides resistance to compression. This is similar to that shown in FIG. 1 and the result is that the first microparticles 12 have a large crush strength, so the material can be very resistant to compression forces, whilst still being lightweight in view of the second microparticles 14 being of relatively high volume and low density.

Further microparticles (not shown) can fit into the gaps 16 between the first microparticles 12 and the second microparticles 14, and, where those further microparticles have a density less than that of the matrix material 13, the material can be made lighter. In such an arrangement, the random close packing of the particles can be 80% or higher, thereby reducing the amount of matrix material required to form the resultant material.

As shown in FIG. 5, the volume percentage of the first microparticles is important in respect of providing strength to the material. The X-axis is the percentage volume of the first plurality of microparticles, with the second plurality of microparticles making up the rest of the volume of microparticles in the material. In the arrangement shown in the graph of FIG. 5, the ratio of the diameter of the second microparticles to the first microparticles is 3, with a crush strength ratio of the same particles being 30. As can be seen in the graph, at low percentage volumes, the structural percolation is insufficient to provide strength to the material, and, at the other extreme, the density of the material is increased to a level that the material is overly dense. Therefore, a range of between 20% and 70% as the volume of the first plurality of microparticles is a useful range, with between 30% and 60% creating a material with sufficient structural percolation to resist significant loads, whilst having a sufficiently low density to be a lightweight material. It should be noted that the slope of the curve, and the position of the percolation threshold, v_{crit}, of the graph of FIG. 5 is dependent upon the size ratio of the first and second microparticles. In relation to the slope shown in the Figure, the following applies:

$$Boltzmann Sigmoid$$

$${σ}_{l} + \frac{( {σ}_{u} - {σ}_{l} )}{( 1 + {e}^{\frac{{v}_{crit} - {v}_{f}}{slope}} )}$$

$${σ}_{u} = 2.2$$

$${σ}_{l} = 1$$

$${v}_{crit} = 26.6 \%$$

$$slope = 4.76$$

In one method of making the material of the present invention, initially, the first microparticles and the second microparticles are mixed together. It will be appreciated that other items may be included at this stage, such as a third type of microparticles or other components. Once mixed, a matrix material can be added, which may be in the form of a premixed epoxy resin and, in some embodiments, a curing agent may be combined with the matrix material. Once the matrix material and microparticles have been combined, the material can be cured, which may be through the application of heat, pressure and/or light to create a solid product.

In another arrangement, a first microparticle is mixed with the matrix material, which, again, may be an epoxy resin, and a second microparticle may be mixed with a curing agent. These two mixtures can be kept separate to avoid creating the material until it is required. When needed, the two mixtures are combined and may be shaped prior to the curing process. It will be appreciated that other components may be added to one or both of the mixtures prior to them being combined.

In an alternative arrangement, the microparticles can be mixed together and one portion of the microparticle mix is combined with the matrix material and a second portion of the microparticle mix is combined with a curing agent. Again, when required, the two mixtures can be combined and cured to form a finished product. The curing time and temperature will depend upon a number of factors; however, in as an example, two hours at 70 degrees Centigrade should be sufficient.

The material may also be used in an injection moulding process. In such an arrangement, a mixture of first and second microparticles, can be added into an extruder barrel via a downstream feed, after the main melt. In such an arrangement, the material being extruded, for example, plastics material, can act as the matrix material. In such an arrangement, the cooling of the matrix material, with the microparticles incorporated therein creates the material that is used for the moulded product. The lightweight material of the present invention can be used as a sheet or bulk moulding compound or injected into a final part.

It will be appreciated that the material may be used in an extrusion process, wherein the microparticles are combined with the matrix material and extruded to form a product made from the material.

Other methods for creating the composite may be employed, which includes known methods of creating sandwich structures.

Below are example compositions that may be used to create a material in accordance with the present invention. In each of the above examples, the matrix material used was Bisphenol A diglycidyl ether.

### Example 1

| | Microparticle 1 | Microparticle 2 | Microparticle 3 |
|---|---|---|---|
| Type | Glass | Glass | None |
| | microspheres | microspheres | |
| Diameter | 60 | 20 | N/A |
| (microns) | | | |
| Crush | 3.5 | 110 | N/A |
| strength | | | |
| (MPa) | | | |
| Density (g/cc) | 0.20 | 0.46 | N/A |
| % volume of | 90 | 10 | 0 |
| total | | | |
| microparticles | | | |

### Example 2

| | Microparticle 1 | Microparticle 2 | Microparticle 3 |
|---|---|---|---|
| Type | Glass | Glass | None |
| | microspheres | microspheres | |
| Diameter | 60 | 20 | |
| (microns) | | | |
| Crush | 3.5 | 110 | |
| strength | | | |
| (MPa) | | | |
| Density (g/cc) | 0.20 | 0.46 | |
| % volume of | 70 | 30 | |
| total | | | |
| microparticles | | | |

### Example 3

| | Microparticle 1 | Microparticle 2 | Microparticle 3 |
|---|---|---|---|
| Type | Glass | Glass | None |
| | microspheres | microspheres | |
| Diameter | 60 | 20 | |
| (microns) | | | |
| Crush | 3.5 | 110 | |
| strength | | | |
| (MPa) | | | |
| Density (g/cc) | 0.20 | 0.46 | |
| % volume of | 30 | 70 | 0 |
| total | | | |
| microparticles | | | |

### Example 4

| | Microparticle 1 | Microparticle 2 | Microparticle 3 |
|---|---|---|---|
| Type | Glass | Glass | None |
| | microspheres | microspheres | |
| Diameter | 60 | 20 | N/A |
| (microns) | | | |
| Crush | 3.5 | 110 | N/A |
| strength | | | |
| (MPa) | | | |
| Density (g/cc) | 0.20 | 0.46 | N/A |
| % volume of | 50 | 50 | 0 |
| total | | | |
| microparticles | | | |

### Example 5

| | Microparticle 1 | Microparticle 2 | Microparticle 3 |
|---|---|---|---|
| Type | Glass | Glass | None |
| | microspheres | microspheres | |
| Diameter | 60 | 20 | N/A |
| (microns) | | | |
| Crush | 3.5 | 110 | N/A |
| strength | | | |
| (MPa) | | | |
| Density (g/cc) | 0.20 | 0.46 | N/A |
| % volume of | 10 | 90 | 0 |
| total | | | |
| microparticles | | | |

### Example 6

| | Microparticle 1 | Microparticle 2 | Microparticle 3 |
|---|---|---|---|
| Type | Glass | Glass | Glass |
| | microspheres | microspheres | microspheres |
| Diameter | 65 | 30 | 60 |
| (microns) | | | |
| Crush | 1.72 | 125 | 2.07 |
| strength | | | |
| (MPa) | | | |
| Density (g/cc) | 0.125 | 0.6 | 0.19 |
| % volume of | 10 | 80 | 10 |
| total | | | |
| microparticles | | | |

The material may be used in manufacturing technologies and may be particularly useful in the fields of aerospace technology, automotive technology, transportation and electronics. It may be used in the construction of transport structures, including pallets and unit load devices, especially as the core of such items. Similarly, the material may be employed as an adhesive or potting compound, depending upon the matrix material that is selected. To that end, parts made from the material disclosed herein, adhesives and/or potting compounds may be used in aerospace applications, for example in satellites, for aeroplane parts, such as cabin flooring, interior structures, seats and overhead bins. Similarly, the material may be used to construct trolleys, such as galley trolleys. The material could also be used for other lightweight structures, such as in wind turbines, for example a blade cores or nacelles, and it may be useful in the manufacture of car bumpers, interior vehicle parts and body panels.

Where a solid material is required, a curing process may be employed, which may involve the application of heat, pressure and/or light to create a solid product.

The microparticles may be selected from a group comprising: porous, foraminous, foamed and refractory particles.

The first microparticle and the second microparticle should be distinctly different. For example, whilst microparticles may be sized in relation to an average diameter within a range, two different ‘sizes’ should be employed, which is to say a microparticle product with a first diameter and a microparticle product with a second diameter will be two different microparticle products, rather than variations within a single product. As an example, a first choice of microsphere may have a diameter of should have a 80 microns and the second choice of microsphere may have a diameter of 20 microns; however, both choices of first and second microspheres should not be 30 microns, otherwise the benefits of the present invention are not obtained to an advantageous degree.

In respect of crush strength, a standard testing method is employed. For example, that used by 3M in respect of their data sheets in which Isostatic Crush Strength refers to the pressure at which an average lot of material has 90% or higher survival.

The density of particles such as microspheres can be taken from the relevant data sheets and it may be determined by pycnometry methods, such as helium pycnometer pycnometry.

The tensiles strength of the matrix material can be determined using standard tensile test, for example ISO 527-1:2019.

1. A material comprising:
a plurality of first microparticle, the first microparticle having a first crush strength and a first density;
a plurality of second microparticle, the second microparticle having a second crush strength and a second density; and
a matrix material;
wherein the crush strength of the first microparticle is greater than the tensile strength of the matrix material;
wherein the matrix material constitutes less than 50% of the material volume; and wherein the density of the first microparticle is greater than, or equal to, the density of the second microparticle and both the first microparticle and the second microparticle have a density less than the matrix material.

2. A material according to claim 1, wherein the matrix material constitutes less than 40% of the material volume.

3. A material according to claim 1, wherein the matrix material constitutes less than 30% of the material volume.

4. A material according to claim 1, wherein the crush strength of the first microparticle is greater than the crush strength of the second microparticle.

5. A material according to claim 1, wherein the crush strength of the first microparticle is greater than 200 bar.

6. A material according to claim 1, wherein the density of the second microparticle is less than 600 kg/m³.

7. A material according to claim 6, wherein the density of the second microparticle is less than 400 kg/m³.

8. A material according to claim 1, wherein the first microparticle and/or the second microparticle is selected from a group comprising: glass microspheres; ceramic microspheres; metal microspheres; polymer microspheres; microballoons; microspheroids; fibres; and platelets.

9. A material according to claim 1, wherein the material comprises a plurality of a third microparticles selected from a group comprising: glass microspheres; ceramic microspheres; metal microspheres; polymer microspheres; microballoons; microspheroids; fibres; and platelets.

10. A material according to claim 1, wherein the plurality of first microparticles forms a structural percolated network within the material.

11. A material according to claim 1, wherein the total volume of the first plurality of microparticles is between 30% and 60% of the total volume of microparticles in the material.
